(19) United States
(12) Patent Application Publication
(10) Pub. No.: US 2018/0118584 A1
(43) Pub. Date: May 3, 2018

(54) METHOD FOR WATER PURIFICATION BY DIRECT OSMOSIS AND CRYSTALLISATION OF CLATHRATES HYDRATES

(71) Applicant: BGH, Lacq (FR)

(72) Inventor: Bruno Mottet, GUIDEL (FR)

(73) Assignee: BGH, Lacq (FR)

(21) Appl. No.: 15/563,916

(22) PCT Filed: Mar. 31, 2016
(86) PCT No.: PCT/EP2016/057063

§ 371 Date: Oct. 2, 2017

(30) Foreign Application Priority Data
Apr. 3, 2015 (EP) 15305505.8

(51) Int. Cl. C02F 1/44; C02F 1/52; B01D 61/00; B01D 9/00

(52) U.S. Cl. CPC C02F 1/445; C02F 1/52; C02F 2101/12; B01D 9/0009; C02F 2001/5218; B01D 61/005

(57) ABSTRACT

A method is disclosed for purifying, by direct osmosis, a first liquid including water and at least one impurity, in which the method comprises the consecutive steps of: contacting the first liquid with a first side of a semi-permeable membrane, a second aqueous liquid containing an osmotic agent being in contact with the second side of the semi-permeable membrane, whereby water is extracted by direct osmosis from the first liquid through the semi-permeable membrane and passes into the second liquid containing the osmotic agent; forming clathrates hydrates of a host molecule in the second liquid containing the osmotic agent into which the water has passed; separating the clathrates hydrates from the second liquid containing the osmotic agent; and dissociating the separated clathrates hydrates to obtain pure water and the host molecule.

### TECHNICAL FIELD

The invention relates to a method for purifying water, water purification by direct osmosis and crystallisation of clathrates hydrates.

More precisely, the invention is concerned with a method for purifying a liquid comprising water and impurities which implements the combination of a reverse osmosis technique and of a technique for crystallising clathrates hydrates.

By purifying water, water purification, it is generally meant any operation consisting in treating a water containing impurities at an initial content such that at the end of this operation, the final content of impurities is lower than the initial content.

By impurity, it is meant any element, molecule, ion, or other, different from the elements constituting pure water, that is H₂O, OH⁻, and H⁺.

This purification method may be, for example, a method for desalinising for example sea water, a method for treating industrial production waters, or a method for treating landfill leachates.

### STATE OF THE PRIOR ART

Among water purification methods, purification methods involving the osmosis phenomenon are known.

Osmosis is a natural phenomenon which is based on the following principle: when two aqueous solutions with different concentrations of impurities such as salts, are separated by a semi-permeable membrane, that is permeable to water and impermeable to impurities such as salts, pure water will pass from the less concentrated solution to the more concentrated solution.

Indeed, the semi-permeable membrane prevents salts dissolved in water from passing therethrough, such that the transfer of pure water is the only means which enables a concentration balance to be established on both sides of the membrane.

A direct consequence of the pure water transfer to the compartment containing the concentrated solution is a rise in the pressure of the solution on the membrane. This pressure is called the osmotic pressure Posm.

Two water treatment technologies make use of the properties of semi-permeable membranes and of the osmosis phenomenon, it is on the one hand the so-called reverse osmosis technology, and on the other hand the so-called direct (forward) osmosis technology.

Currently, the most developed technology is the reverse osmosis technology. It consists in applying to the concentrated solution a pressure much higher than the osmotic pressure to reverse the flux of water molecules through the semi-permeable membrane.

The reverse osmosis technology enables a high purity water to be produced, but it is a technology which implements high pressures, much higher than the osmotic pressure Posm, and the energy consumption of which is very significant. Consequently, the investment costs and operating costs of reverse osmosis facilities are high.

Direct osmosis, in turn, directly makes use of the osmotic pressure. It consists in separating by a semi-permeable membrane the solution to be treated containing impurities such as salts, from a solution highly concentrated in a chemical element selected for its osmotic power—called an osmotic agent—which will be readily able to be extracted from water in order to obtain pure water.

Thus, document U.S. Pat. No. 3,130,156 [1] describes a direct osmosis apparatus for producing potable water from saline water wherein the osmotic agent is ammonium bicarbonate which is removed from water by heating at a temperature from 35° C. to 60° C. to give water, carbon dioxide and ammonia.

Document U.S. Pat. No. 3,532,621 [2] describes a method for desalinizing sea water or brackish waters by direct osmosis, wherein the osmotic agent is in particular a compound the solubility of which significantly changes upon a variation in the temperature or pressure of the aqueous solution which contains them.

Document U.S. Pat. No. 6,391,205 [3] relates to a method for desalinizing sea water or brackish waters, by direct, for award, osmosis which uses osmotic agents having highly temperature dependent such as KNO₃, Na₃PO₄, Na₃PO₄, sucrose, SO₂, Ce(SO₄)₃, and CO₂.

Document US-A1-2010/0108587 (U.S. Pat. No. 8,002,989) [4] describes a direct osmosis desalinising method, wherein water is extracted from a first solution, such as seawater, by using a second concentrated solution to draw pure water from the first solution to the second solution through a semi-permeable membrane. The second solution contains an osmotic agent which is preferably chosen from ammonia and carbon dioxide gases and the products formed when dissolving them in water, namely ammonium carbonate, ammonium bicarbonate, and ammonium carbamate.

The document by Jeffrey R. Mc Cutcheon et al. “A novel ammonia-carbon dioxide forward (direct) osmosis desalination process”, Desalination 174 (2005) 1-11 [5] after noticing that there was no satisfactory osmotic agent until then, provides a reverse osmosis desalinising method which uses an ammonium bicarbonate solution (“draw solution”) to extract water from a saline water through a semi-permeable polymeric membrane. When moderately heated, ammonium bicarbonate decomposes into ammonia and carbon dioxide gas, which can be separated from the pure water produced, and recycled as osmotic agents.

The document by Andrea Achilli and al.: “Selection of inorganic-based draw solutions for forward osmosis applications”, Journal of Membrane Science 364 (2010), 233-241 [6] describes a protocol for choosing the most suitable osmotic agent solutions for direct osmosis. Fourteen solutions are evaluated in that document, that is solutions of CaCl₂, Cₐ(NO₃)₂, KBr, KCl, KHCO₃, K₂SO₄, MgCl₂, MgSO₄, NaCl, NaHCO₃, Na₂SO₄, NH₄Cl, NH₄HCO₃, and (NH₄)₂SO₄.

The document by Katie S. Bowden et al.: “Organic ionic salt draw solutions for osmotic membrane bioreactors”, Bioresource Technology 122(2012), 207-216 [7], relates to the use of solutions of organic salts as solutions of osmotic agents (“draw solutions”) in osmotic membrane bioreactors. Although organic salts renewal costs are slightly higher than those for mineral salts, their efficiency and biodegradation potential make that they are particularly suitable for a use in osmotic membrane bioreactors.

It is apparent from the preceding that the ability of the direct osmosis technology to purify water in an economical way depends on selecting an efficient osmotic agent fulfilling two main criteria:
the osmotic agent has to promote a good membrane efficiency—that is a strong real osmotic power by taking membrane polarisation phenomena and reverse ionic flows into account—to optimise the filtering area and thus the membrane costs;
the osmotic agent has to be readily extracted, separated, from the concentrated solution on the side of the semi-permeable membrane opposite to the solution to be purified, to recover water having an optimum purity.

Another requirement the osmotic agent should also fulfill is its safety in the case of the potable water production. The osmotic agent cost is also to be taken into account.

Most of the aforementioned documents relating to purification methods, in particular desalination methods, by reverse osmosis, aim at choosing an osmotic agent having the best compromise between the abovementioned two main requirements.

Until now, no osmotic agent has however been fully satisfactory and enabled an acceptable compromise to be achieved.

To date, it seems however that the best compromise is achieved with an osmotic agent consisting of ammonium carbonate, ammonium bicarbonate and ammonium carbamate. Indeed, it is a family of compounds based on ammonia and carbon dioxide which can coexist in solution.

The main advantage of this osmotic agent resides in the fact that it can be extracted in the form of a gas as ammonia, carbon dioxide, and water, whereas its osmotic power remains acceptable.

However, in order to carry out this extraction, the solution has to be heated at a temperature from 60° C. to 100° C. which, because of the presence of water, implies a significant energy consumption. Then, ammonia and carbon dioxide react to give the osmotic agent again such as ammonium bicarbonate which is then recrystallised for the recycling thereof in the solution. However, the recrystallisation operation is complex and high energy consuming, and the operation of reinjecting the osmotic agent into water is complex as well.

Thus, it appears that, even if the extraction of the aforementioned osmotic agents, that is ammonium carbonate, ammonium bicarbonate and ammonium carbamate, is easier than those of most of the other osmotic agents currently implemented in the direct osmosis methods, it still have some drawbacks and it is not fully satisfactory. In particular, it does not enable highly concentrated solutions, in particular in NaCl exceeding for example concentrations in the order of 150 g/l, to be treated.

On the other hand, document [6] highlights that many compounds have much higher osmotic abilities than the family of ammonium carbonates such as ammonium carbonate, ammonium bicarbonate and ammonium carbamate, but that their implementation as an osmotic agent in a direct osmosis method is not contemplated because of issues encountered with extraction, separation of such compounds.

Thus, in the light of the above, there is a need for a method for purifying a liquid such as water by direct osmosis which has not the drawbacks, defects, limitations and disadvantage of the direct osmosis purification methods of the prior art, represented in particular by the abovementioned documents, and which solves the problems of the methods for purifying a liquid by direct osmosis of the prior art in particular as regards the choice of the osmotic agent.

In particular, there is a need for a method for purifying a liquid by direct osmosis which does not have the limitations of the methods of prior art as regards the choice of the osmotic agent due in particular to issues encountered when separating this agent.

Finally, there is a real need for a method enabling highly concentrated solutions, in particular in NaCl, for example beyond concentrations in the order of 150 g/l, to be treated by direct osmosis.

The goal of the present invention is to provide a method and a facility which, inter alia, fulfill these needs.

### DISCLOSURE OF THE INVENTION

This goal and other goals are achieved, according to the invention, by a method for purifying a first liquid comprising water and at least one impurity, by direct osmosis, in which the following successive steps are performed:

a) contacting the first liquid with a first side of a semi-permeable membrane, a second aqueous liquid containing an osmotic agent being in contact with the second side of the semi-permeable membrane, whereby water is extracted by direct osmosis from the first liquid through the semi-permeable membrane and passes into the second liquid containing the osmotic agent;

b) forming clathrates hydrates of a host molecule in the second liquid containing the osmotic agent into which the water has passed;

c) separating the clathrates hydrates from the second liquid containing the osmotic agent; and

d) dissociating the separated clathrates hydrates to obtain pure water and the host molecule.

The second liquid, for example the second solution, containing the osmotic agent can be called a draining, draw, liquid, for example a draining, draw, solution.

The method according to the invention comprises a specific sequence of specific steps which has never been described in the prior art.

The method according to the invention associates the direct osmosis technique with the technique of crystallising clathrates hydrates.

The association of both these techniques has not been described nor suggested in the prior art.

The method according to the invention, by associating both these techniques, no longer has all the drawbacks of the direct osmosis purification methods of the prior art, because it is no longer necessary to separate the osmotic agent from the second liquid, pure water being recovered from this second liquid containing the osmotic agent by crystallisation and then dissociation of clathrates hydrates.

It is reminded that the word “clathrate” comes from the Greek word “Klathron” which means closing. Clathrates designate a family of crystalline structures having the form of a cage capable of trapping a so-called host molecule therewithin, in their hearts.

In the case of hydrates, water molecules are organised as a cage only held by weak bonds of the hydrogen type and trap a host molecule therewithin, in their hearts.

The most known clathrates are gas-hydrates which comprise a host molecule which is gaseous like methane, ethane, butane, propane, hydrogen sulphide, or carbon dioxide.

These gas-hydrates are formed under very accurate pressure and temperature conditions (that is, generally at pressures of several tens of atmospheres and at temperatures slightly higher than 0° C.) depending on the nature of the gas(es). Some hydrocarbons, such as cyclopentane clathrate, however crystallise under an atmospheric pressure up to 7° C.

Because of their structural “anionic” nature, the clathrates hydrates have the singularity to crystallise very selectively, that is without including impurities within their crystalline building. Their crystallisation is thus nearly independent of the nature and concentration of the different impurities present in the solution, only the crystallisation temperature of the clathrate hydrate is likely to vary as a function of the nature and of the concentration of impurities.

In an impurities rich solution and containing host molecules likely to form a clathrate, hydrate crystallisation by pumping water molecules contributes to concentrate the solution in impurities. In other words, clathrate crystallisation results in extracting water molecules from the solution as long as host molecules are available.

Once it is separated from the liquid phase, hydrate melting enables an extremely pure water to be obtained at temperatures between 0 and 10° C. if the host molecule is readily separable in the form of a gas or by settling for insoluble hydrocarbons such as cyclopentane.

Under controlled conditions, the crystallisation of clathrates hydrates, in particular of cyclopentane, is relatively easy.

The entire cycle up to the recovery of ultra-pure water consumes very little energy since the exothermic nature of crystallisation and endothermic nature of dissociation enable a thermal loop to be set.

According to the invention, by coupling both technologies of direct osmosis and crystallisation of clathrates hydrates, it is possible to provide an overall optimised method for purifying a liquid, in particular an impurity loaded water.

The technique of crystallisation of clathrates hydrates used for producing pure water, because it can be implemented independently of the nature of the compounds found in the second liquid, that is substantially the osmotic agent, enables the best osmotic agent to be selected to optimise the initial direct osmosis step without regard to the subsequent extraction of this osmotic agent, for the simple reason that this agent is not extracted from the second liquid.

Direct osmosis, by generally implementing a draining, draw, synthetic solution of osmotic agent which is stable and controlled, (in comparison with the different solutions that will be desired to be purified) enables in turn the extraction of ultra-pure water to be optimised by the clathrate pathway.

It can be said that the method according to the invention synergistically associates the direct osmosis technique with the technique of crystallising clathrates hydrates.

The method according to the invention dramatically widens the choice of osmotic agents, because this choice is made on the one and single criterion of their osmotic efficiency, without having to take their separation into account.

In other words, the second criterion set out above is no longer considered when choosing the osmotic agent.

Advantageously, the method according to the invention is continuously performed.

The first liquid may be referred to as an aqueous liquid containing at least one impurity or else as an impurity loaded water.

The first liquid may be a solution (in particular an aqueous solution) containing dissolved impurities or a suspension (in particular an aqueous suspension) containing impurities which are dispersed, suspended, or else a solution (in particular an aqueous solution) containing dissolved impurities and impurities suspended in said solution (in particular an aqueous solution).

Generally, the first liquid and the second liquid may be aqueous solutions.

There is no limit regarding the impurity(ies) contained by the first liquid and the method according to the invention ensures purification of liquids regardless of the impurities they contain.

By impurity, as already set out, it is meant any element, molecule, ion, or other, different from the elements constituting pure water, that is H₂O, OH⁻, and H⁺.

The impurity may be in particular chosen from mineral salts such as NaCl, organic salts, water soluble organic compounds, and mixtures thereof.

The method according to the invention also ensures purification of liquids which have wide ranges of impurity concentrations.

The first liquid may have in particular a concentration of impurity(ies) from 1 mg/L to 500 g/L, preferably 100 mg/L to 250 g/L.

Consequently, there is no limit regarding the nature of the liquid which may be treated by the method according to the invention as well.

The first liquid may in particular be chosen from sea water; brackish waters; landfills leachates; oil production waters; waters from shale gas extraction by the hydraulic fracturing technique; agro-food industry liquids such as fruit juices or coffee; pharmaceutical industry liquids; chemical industry liquids; mining effluents, for example sulphates, phosphates or carbonates loaded mining wastes; metallurgical industry effluents; nuclear industry effluents; reverse osmosis concentrates; scale-forming solutions; paper industry effluents; saline aquifers.

The method according to the invention may in particular enable solutions highly concentrated in impurities, in particular in NaCl, for example with concentrations beyond 150 g/L, to be treated.

The first liquid may therefore be chosen from NaCl aqueous solutions the NaCl concentration of which is higher than 150 g/L.

According to one of the essential advantages of the method according to the invention, the osmotic agent can be chosen independently of its ability to be separated from the second liquid, and the choice of this osmotic agent is thus definitely no longer limited, unlike direct osmosis purification methods of the prior art.

The criteria which will govern the choice of the osmotic agent are thus criteria intrinsically related to the direct osmosis method and no longer to its ability to be separated at all.

The osmotic agent is generally chosen by taking as a criterion the osmotic efficiency and possibly the economic profitability of the method depending on the nature of the solution to be purified.

The osmotic efficiency is a known, objective, and concrete parameter, defining an osmotic agent and the man skilled in the art will readily choose a suitable osmotic agent by taking the osmotic efficiency as a selection criterion.

The same is true of the economic profitability which is also a known, objective, and concrete parameter.

The osmotic agent may be in particular chosen from salts, in particular mineral salts, ionic compounds, proteins, and carbohydrates.

The osmotic agent may be chosen for example from all the compounds mentioned in documents [1] to [7], the content of which could be referred to as in this regard. Among the salts, NaCl, NH₄Cl, MgCl₂, NaHCO₃, Na₂SO₄, KCl, KHCO₃, NH₄HCO₃, (NH₄)SO₄, K₂SO₄, KBr, Ca(NO₃)₂, MgSO₄, CaCl₂ etc may be mentioned.

A preferred osmotic agent is sodium chloride NaCl. Indeed, it turned out that this salt was an osmotic agent which had optimum properties for use in the method according to the invention, because it has a very high osmotic power, without affecting the formation of clathrates hydrates by crystallisation, and these clathrates hydrates can be easily separated.

Advantageously, the second aqueous liquid is a synthetic aqueous liquid, such as a synthetic aqueous solution, with regulated, controlled, composition and concentration; in other words, with regulated, controlled, determined, accurately known composition and concentration.

Preferably, the second aqueous liquid, such as an aqueous solution, only consists of water and the osmotic agent, and its composition is thus perfectly regulated, controlled; and the concentration of the osmotic agent is also regulated, controlled.

By synthetic aqueous liquid, it is meant that this liquid can be prepared, synthesised, in a perfectly controlled manner from its components, that is preferably only water and the desired osmotic agent at an accurately determined concentration, for the purpose of being used in the method according to the invention.

In the second liquid, and because it is precisely a synthetic liquid, the osmotic agent and its concentration may be chosen so as to be closely adapted (“tailored”) to the first liquid to be treated.

Generally, the concentration of the osmotic agent in the second liquid is adapted so as to generate an osmotic pressure gradient with the concentration of impurities in the first liquid to be purified which is sufficient to drain, draw; water molecules, from the first liquid, such as a solution to be purified to the second liquid.

The concentration of the osmotic agent in the second liquid thus generally depends on the nature and concentration of the impurities in the first liquid, such as a solution, to be purified.

This concentration can be easily determined by the man skilled in the art which consequently will conduct the synthesis of the second liquid.

The host molecule may be in particular chosen from gases having a low molecular weight such as oxygen, nitrogen, CO₂, H₂S, argon, krypton and Xenon or even from halogenated hydrocarbons, or hydrocarbon gases such as methane, propane, ethane and butane.

The gaseous host molecules require high pressures.

Advantageously, the host molecule is chosen from host molecules which enable clathrates hydrates to be crystallised at atmospheric pressure and at temperatures higher than ice (or water) crystallisation.

Advantageously, the host molecule is water immiscible.

Advantageously, the host molecule is chosen from molecules which form a clathrate hydrate having a specific gravity lower than the specific gravity of the second liquid, for example lower than 1.3, preferably lower than 1.0.

A preferred host molecule is cyclopentane or cyclohexane.

Indeed, cyclopentane clathrate hydrate associates 17 water molecules by cyclopentane molecule in the structure [C₅H₁₀].17H₂O.

Cyclopentane enables clathrates hydrates to be crystallised under atmospheric pressure at temperatures higher than ice crystallisation temperature, since cyclopentane clathrate hydrate has a crystallisation temperature (or equilibrium temperature) of about 7° C. in the presence of pure water.

Cyclopentane is in the liquid state under normal conditions. It is water immiscible and enables clathrates hydrates having a specific gravity lower than that of water to be crystallised, because cyclopentane clathrate hydrate has a specific gravity of 0.95.

Advantageously, the second liquid containing the osmotic agent separated in step c), is brought, sent, back to the second side of the semi-permeable membrane.

Therefore, it is not necessary to separate the osmotic agent that is particularly advantageous and decreases the overall cost of the method according to the invention.

Advantageously, the host molecule obtained in step d) is brought, sent, back in step b).

Thanks to this recycling, the consumption of the host molecule is dramatically reduced, which also decreases the overall cost of the method according to the invention.

The invention also relates to a facility for implementing the method as described in what precedes, for purifying a first liquid comprising water and at least one impurity by direct osmosis, said facility comprising:
an osmotic enclosure separated into a first chamber and a second chamber by a semi-permeable membrane;
means for sending a first liquid comprising water and at least one impurity into the first chamber to contact a first side of the semi-permeable membrane;
means for sending a second aqueous liquid containing an osmotic agent into the second chamber to contact a second side of the semi-permeable membrane;
a reactor for crystallising and growing clathrates hydrates in which clathrates hydrates of a host molecule are formed in the second liquid containing the osmotic agent;
means for removing the second liquid from the second chamber of the osmotic enclosure and sending it into the reactor for crystallising and growing the clathrates hydrates;
means for separating the clathrates hydrates from the second liquid containing the osmotic agent; and
means for dissociating the clathrates hydrates separated in the means for separating the clathrates hydrates from the second liquid, to obtain pure water and the host molecule.

Advantageously, said facility may further comprise means for sending back the second liquid containing the osmotic agent separated in the means for separating the clathrates hydrates from the second liquid, into the second chamber of the osmotic enclosure.

Advantageously, said facility may further comprise means for sending back the host molecule obtained in the means for dissociating the clathrates hydrates, into the reactor for crystallising and growing clathrates hydrates.

### BRIEF DESCRIPTION OF THE DRAWINGS

FIG. 1 is a simplified flow-sheet, which illustrates an embodiment of the method according to the invention.

FIG. 2 is a scheme which illustrates a facility for carrying out, implementing, the method according to the invention, as well as the implementation of the method according to the invention in this facility.

### DETAILED DISCLOSURE OF PARTICULAR EMBODIMENTS

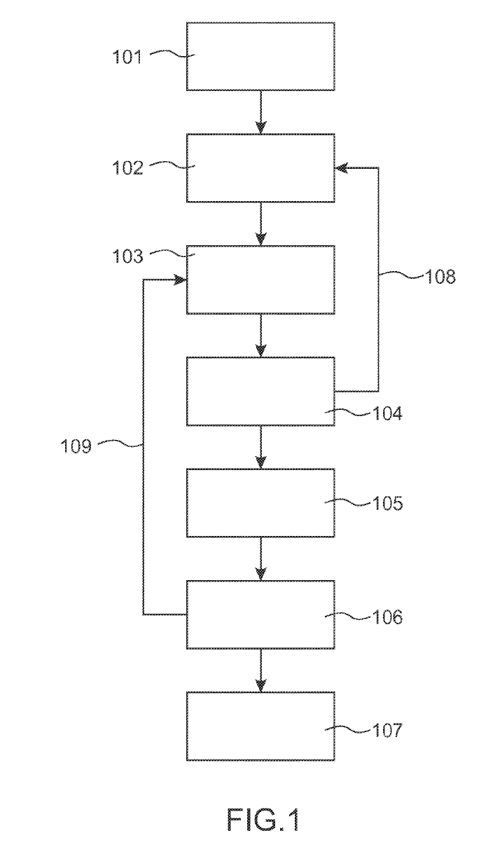

FIG. 1 is a simplified flow-sheet, which illustrates an embodiment of the method according to the invention to purify an impurity loaded water, such as an impurity loaded aqueous solution, for example a saline aqueous solution mainly containing NaCl and other impurities, such as sea water.

Obviously, this saline aqueous solution is only given by way of example, and the method illustrated in FIG. 1 can be used to purify any impurity loaded water.

In this method, water containing impurities 101 forming for example a first solution is provided, and in a first step 102, this water containing impurities is treated by direct osmosis, and the water is extracted from this first solution under the effect of a direct osmosis phenomenon through a semi-permeable membrane up to a second aqueous solution containing an osmotic agent.

This second aqueous solution is generally called a draining, draw, solution.

This second aqueous solution is generally a synthetic solution which only consists of water and of the osmotic agent at a determined concentration. Therefore, this solution only contains one single type of compound in solution, unlike the aqueous solution to be purified.

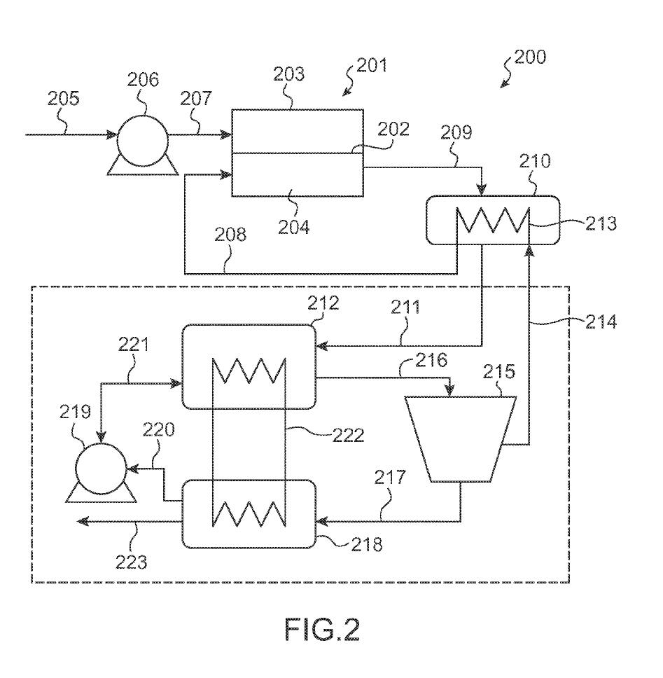

In the facility represented in FIG. 2, this step 102 is carried out in the reactor 201.

During a second step of the method 103, clathrates hydrates are formed in the second solution, by introducing host molecules in the second solution.

In the facility represented in FIG. 2, the clathrates hydrates are formed in the crystallizing and growing reactor 212.

The clathrates which have been thus formed in the second solution are then separated from this solution during the following step 104.

In the facility represented in FIG. 2, the separation of the clathrates hydrates takes place in the separator 215.

The separated clathrates hydrates are then dissociated in a dissociation step 105 to give a mixture of host molecules and purified water.

The host molecules are separated from the mixture during a step 106, and purified water 107, which can be recycled, is thus obtained.

In the facility represented in FIG. 2, the dissociation takes place in the reactor for dissociating the clathrates hydrates 218.

In the method described in FIG. 1, the direct osmosis method 102 extracts water from the first solution up to the second solution, and the formation of clathrates hydrates 103 in the second solution and then the dissociation 105 thereof, associated with the direct osmosis method thus enables from the first solution, at the end of the method, a purified water 107 to be obtained, as a final product which is recovered and which can be used.

The second solution containing the osmotic agent which is obtained during step 104 after separating the clathrates hydrates from said second solution, is recycled to the direct osmosis step 102 to be used again therein. The recycling of the second solution to the osmosis step 102 is illustrated by the arrow 108 in FIG. 1.

In the same way, the host molecules which are collected during the separation step 106 may be recycled in the step of forming the clathrates hydrates 103. The recycling of the host molecules to the step of forming the clathrates hydrates is illustrated by the arrow 109 in FIG. 1.

FIG. 2 is a schematic view which shows an embodiment of a facility for implementing the method according to the invention, continuously implemented, to purify an impurity loaded water, such as an impurity loaded aqueous solution, for example a saline aqueous solution mainly containing NaCl and other impurities.

Of course, this saline aqueous solution is only given by way of example and the method illustrated in FIG. 2 may be used to purify any impurities loaded water.

The facility of FIG. 2, which can be called a purification facility 200 first comprises an osmotic reactor or enclosure 201 which is separated by a semi-permeable membrane 202 into a first compartment or chamber 203 and a second compartment or chamber 204.

The impurity loaded water to be purified forms a first stream which is introduced into the facility by the pipe 205, and then is sent through a pump 206 and a pipe 207 into the first compartment or chamber 203 of the osmotic reactor 201.

A so-called osmotic agent solution, comprising water and an osmotic agent, such as NaCl, forms a second stream, which is conveyed through a pipe 208 in the second compartment 204 of the osmotic reactor 201.

The osmotic agent solution is generally a solution that can be referred to as a controlled, regulated synthetic solution. This means that the composition and concentration of this solution are perfectly controlled and that it does contain little or no, besides the osmotic agent, impurities and undesirable substances. In particular, the choice of the osmotic agent as well as its concentration are perfectly controlled. The osmotic power, potential of the osmotic agent solution can thus be in particular accurately controlled, set, adjusted.

According to the invention and this is one of the advantages of the method according to the invention in comparison with reverse osmosis methods of prior art which are not associated with a clathrates hydrates crystallisation technique, there is no limit as regards the choice of the osmotic agent.

Indeed, this choice is not restricted by problems related to recovering, regeneration, and recycling of some osmotic agents, since water is purified by the clathrates hydrates crystallisation technique and not by separating the osmotic agent from the solution containing it.

The osmotic agent may be chosen for example from salts, ionic compounds and proteins.

In a preferred embodiment, the osmotic agent is sodium chloride NaCl.

Other osmotic agents which may be used are the salts mentioned above.

Since the choice of the osmotic agent according to the invention is in no way limited, this choice may be made in order to fulfil one or more criteria which can be mostly freely chosen.

All the criteria set out hereinafter could be actually gathered under one and a single overall criterion which is the osmotic efficiency criterion.

A first mandatory criterion which governs the choice of the osmotic agent is that the osmotic agent has to be capable of creating a water flow through the semi-permeable membrane from the first compartment to the second compartment of the osmotic reactor. This criterion is imperative, because otherwise there is simply no osmosis.

Another criterion, being optional and preferable, is that the reverse diffusion of the osmotic agent from the second compartment to the first compartment has to be limited. Indeed, otherwise the efficiency loss is significant.

According to yet another criterion, the osmotic agent may be chosen in order to obtain a water flow by unit area of the semi-permeable membrane which is stable and as high as possible, in other words, in order to obtain a high yield of the membrane. An osmotic agent which fulfils these criteria is NaCl.

Once again, to fulfil these criteria, the choice of the osmotic agent is not limited by recovering or regeneration of the osmotic agent in a subsequent phase.

Another criterion or a further criterion which could possibly govern the choice of the osmotic agent is the semi-permeable membrane used, but this criterion is not crucial. One of the advantages to choose the osmotic agent as a function of the type of membrane used is that the osmotic method can be optimised.

To all the mandatory or optional criteria listed above which all fall within the overall scope of the osmotic efficiency criterion, the economic criterion, that is the cost of the osmotic agent can be added, even if, generally, said osmotic agent remains permanently in the second solution or draining, draw, solution and thus has not to be constantly replenished.

The osmotic agent solution forming the second stream, which is conveyed through the pipe 208 into the second compartment or chamber 204 of the osmotic reactor or enclosure 201 is a solution which can be referred to as a draining, draw, solution.

It is to be noted that the concentration of osmotic agent of this draining, draw, solution may be, but is not necessarily, higher than the concentration of impurities of the solution to be treated.

Indeed, even if a higher concentration of osmotic agent increases the osmotic pressure, however it is the nature of the osmotic agent that is prevalent. Some osmotic agents can thus generate higher osmotic pressures while having concentrations lower than the content of impurity(ies) of the solution to be purified.

Pure water, from the impurities loaded water to be purified, passes under the effect of the reverse osmosis through the semi-permeable membrane 202 from the compartment 203 up to the compartment 204 of the osmotic reactor 201.

Thus, in the compartment 204, an osmotic agent solution is formed, which is diluted with respect to the osmotic agent solution, relatively more concentrated, initially present in the compartment 204 and which had been sent in the same through the pipe 208.

The diluted osmotic agent solution is discharged from the second compartment 204 through a piping 209, which conveys this solution into a cooling device 210. This solution is then sent through a pipe 211, in a reactor for crystallising and growing the clathrates hydrates 212 in which there are host molecules.

The refrigerating device 210 comprises a heat exchanger 213 in which a heat exchange takes place between the diluted osmotic agent solution and the osmotic agent solution (see below) which flows in a pipe 214 and then in the pipe 208.

Suitable heat exchangers are known to the man skilled in the art and thus will not be described in more detail.

Water contained in the cooled diluted osmotic agent solution conveyed by the piping 211, and the host molecules which are in the reactor 212 form clathrates hydrates which grow in this reactor for crystallising and growing the clathrates hydrates 212.

As a host molecule, cyclopentane may preferably be used, but also other host molecules may be used, for example gaseous molecules such as methane, ethane, butane, propane, hydrogen sulphide, carbon dioxide, or mixtures thereof.

Generally, the host molecule is chosen so as to have no influence on the rest of the method. Consequently, the host molecule may be chosen according to economic criteria or other criteria.

It is particularly advantageous to use cyclopentane as a host molecule, because it enables clathrates hydrates to be formed in the reactor for crystallising the clathrates 212 at atmospheric pressure, that is under a pressure of 1 bar and at a temperature generally between −20° C. and 6° C.

It is to be noted that the temperature at which the clathrates hydrates are formed in the reactor 212 depends on the concentration of the osmotic agent in the reactor 212. Indeed, generally, the concentration of osmotic agent lowers the crystallisation temperature of clathrates.

As water is used to form the clathrates hydrates in the reactor 212, a suspension of clathrates hydrates in a concentrated solution of osmotic agent is thus obtained in the reactor 212.

The suspension of clathrates hydrates in a concentrated solution of osmotic agent formed in the reactor 212, is removed from the reactor 212, and is sent into a separator 215 through a pipe 216.

In the separator, the clathrates hydrates are separated from the concentrated solution of osmotic agent by implementing a liquid/solid separation technique.

The liquid/solid separation technique used to separate the clathrates hydrates from the concentrated solution will depend on the type of clathrates hydrates but also on other factors. The man skilled in the art will easily choose the suitable technique as a function of the properties of the clathrates hydrates as for example their particle size.

This liquid/solid separation technique may be chosen for example from conventional liquid/solid separation techniques, such as filtration for example with a filter press, centrifugation.

The concentrated solution of osmotic agent separated in the separator 215 and which thus does not contain clathrates hydrates any longer is removed, from the separator 215, through the pipe 214 which feeds the heat exchanger 213 in order to cool the diluted solution of osmotic agent 209 in the cooling device 210.

The concentrated solution of osmotic agent is then conveyed through the pipe 208 into the second compartment 204 of the osmotic reactor 201.

It is thus noticed that in the facility of FIG. 2, the flow of solution containing the osmotic agent forms a closed loop, and the osmotic agent is recycled into the second compartment 204 of the osmotic reactor 201.

The consumption of osmotic agent is thus limited to the amount initially necessary to form the concentrated solution of osmotic agent and possibly to limited supplies when the facility 200 is in use.

As in the facility of FIG. 2, the solution of osmotic agent is recycled, it is not necessary to recover the osmotic agent, and the osmotic agent can thus be chosen independently of its ability to be recovered, regenerated.

The clathrates hydrates separated in the separator 215 are withdrawn in the separator 215 through a pipe 217 and conveyed in a reactor for dissociating the clathrates hydrates 218, where the clathrates hydrates are separated into host molecules and purified water.

Any known dissociation technique may be used. Generally, the dissociation of crystallised hydrate crystals into water and into host molecules is made by a rise in temperature resulting in melting them. In other words, the crystallised hydrate crystals are molten.

Then, the purified water and the host molecules are separated by settling or outgassing.

The choice of one or the other of the settling and degassing techniques is made depending on the more or less volatile nature of the host molecule.

Thus, in the case where the host molecule is a liquid non miscible with water and which has a specific gravity lower than that of water such as cyclopentane, the dissociation by melting the clathrates hydrates in the reactor 218 forms an emulsion which is introduced into a settler (not represented) to separate purified water from the host molecule. The host molecule is recycled in the reactor 212 by means of a pump 219 and of pipes 220 and 221.

In the case where the host molecule is a gas, and as it is particularly represented in FIG. 2, the gaseous host molecules are directly recovered in the dissociation reactor and recycled in the reactor 212 by means of a pump 219 and of pipes 220 and 221.

In the facility according to the invention, the host molecules are thus recycled and used again which increases the facility economic profitability.

The facility 200 represented in FIG. 2 comprises a second heat exchanger 222 which operates between the reactor for crystallizing and growing the clathrates hydrates 212 and the reactor for dissociating the clathrates hydrates 218 to recover heat energy released by the formation of clathrates hydrates in the reactor for crystallizing and growing the clathrates hydrates 212.

This second exchanger is generally a conventional heat pump.

The heat cycle implemented in the heat exchanger 222 uses very little energy, because the exothermic nature of the crystallisation and the endothermic nature of the dissociation enable a heat loop to be formed.

The purified water is discharged from the reactor 218 or from the settler through a pipe 223 and can be used.

The part of the facility 200 delimited by a dotted line in FIG. 2 corresponds to the part of the facility and of the method which involves the clathrates hydrates, whereas the part which is not delimited by a dotted line corresponds to the part of the facility and of the method which involves reverse osmosis.

Of course, insofar as, in accordance with the basic principle of the method according to the invention, both these parts are combined together, they could be arranged in a different way than that shown in FIG. 2.

1. A method for purifying a first liquid comprising water and at least one impurity, by direct osmosis, in which the following successive steps are performed:
a) contacting the first liquid with a first side of a semi-permeable membrane, a second aqueous liquid containing an osmotic agent being in contact with the second side of the semi-permeable membrane, whereby water is extracted by direct osmosis from the first liquid through the semi-permeable membrane and passes into the second liquid containing the osmotic agent;
b) forming clathrates hydrates of a host molecule in the second liquid containing the osmotic agent into which the water has passed;
c) separating the clathrates hydrates from the second liquid containing the osmotic agent; and
d) dissociating the separated clathrates hydrates to obtain pure water and the host molecule.

2. The method according to claim 1, which is continuously performed.

3. The method according to claim 1, wherein the first liquid and the second liquid are aqueous solutions.

4. The method according to claim 1, wherein the impurity is any element, molecule, ion, or other, different from the elements constituting pure water, that is H₂O, OH⁻, and H⁺.

5. The method according to claim 1, wherein the impurity is selected from mineral salts selected from the group consisting of NaCl, organic salts, water soluble organic compounds, and mixtures thereof.

6. The method according to claim 1, wherein the first liquid is selected from the group consisting of sea water; brackish waters; landfills leachates; oil production waters; waters from shale gas extraction by the hydraulic fracturing technique; agro-food industry liquids; pharmaceutical industry liquids; chemical industry liquids; mining effluents; metallurgical industry effluents; nuclear industry effluents; reverse osmosis concentrates; scale-forming solutions; paper industry effluents; and saline aquifers.

7. The method according to claim 1, wherein the first liquid has a concentration of impurity(ies) from 1 mg/L to 500 g/L.

8. The method according to claim 1, wherein the first liquid is selected from NaCl aqueous solutions the NaCl concentration of which is higher than 150 g/L.

9. The method according to claim 1, wherein the osmotic agent is chosen by taking as a criterion the osmotic efficiency and optionally the economic profitability of the method.

10. The method according to claim 1, wherein the osmotic agent is chosen from salts, wherein the salts are selected from the group consisting of mineral salts, ionic compounds, proteins and carbon hydrates.

11. The method according to claim 10, wherein the osmotic agent is sodium chloride.

12. The method according to claim 1, wherein the second aqueous liquid is a synthetic aqueous liquid, with a regulated, controlled, composition and concentration.

13. The method according to claim 12, wherein the second aqueous liquid only consists of water and the osmotic agent.

14. The method according to claim 1, wherein the host molecule is water immiscible.

15. The method according to claim 1, wherein the host molecule is chosen from host molecules which enable clathrates hydrates to be crystallised at atmospheric pressure and at temperatures higher than that of ice crystallisation.

16. The method according to claim 1, wherein the host molecule is chosen from molecules which form a clathrate hydrate having a specific gravity lower than the specific gravity of the second liquid, optionally wherein the specific gravity is lower than 1.3.

17. The method according to claim 1, wherein the host molecule is cyclopentane or cyclohexane.

18. The method according to claim 1, wherein the second liquid containing the osmotic agent separated in step c), is sent back to the second side of the semi-permeable membrane.

19. The method according to claim 1, wherein the host molecule obtained in step d) is sent back to step b).

20. A system facility for implementing the method according to claim 1, comprising:
an osmotic enclosure separated into a first chamber and a second chamber by a semi-permeable membrane;
means for sending a first liquid comprising water and at least one impurity into the first chamber to contact a first side of the semi-permeable membrane;
means for sending a second aqueous liquid containing an osmotic agent into the second chamber to contact a second side of the semi-permeable membrane;
a reactor for crystallising and growing clathrates hydrates in which clathrates hydrates of a host molecule are formed in the second liquid containing the osmotic agent;
means for removing the second liquid from the second chamber of the osmotic enclosure and sending it into the reactor for crystallising and growing the clathrates hydrates;
means for separating the clathrates hydrates from the second liquid containing the osmotic agent; and
means for dissociating the clathrates hydrates separated in the means for separating the clathrates hydrates from the second liquid, to obtain pure water and the host molecule.

21. The system according to claim 20, further comprising means for sending back the second liquid containing the osmotic agent separated in the means for separating the clathrates hydrates from the second liquid, into the second chamber of the osmotic enclosure.

22. The system according to claim 20, further comprising means for sending back the host molecule obtained in the means for dissociating the clathrates hydrates, into the reactor for crystallising and growing clathrates hydrates.
